(19) United States
(12) Patent Application Publication
(10) Pub. No.: US 2015/0014427 A1
(43) Pub. Date: Jan. 15, 2015

(54) CONTROL VALVE

(71) Applicants: William Yunbiao Shen, Westmont, IL (US); Yan Tan, Plainfield, IL (US); Qursheed Hussain Mohammed, Columbia, SC (US); Keith Steven Schulz, Columbia, SC (US)

(72) Inventors: William Yunbiao Shen, Westmont, IL (US); Yan Tan, Plainfield, IL (US); Qursheed Hussain Mohammed, Columbia, SC (US); Keith Steven Schulz, Columbia, SC (US)

(73) Assignee: International Engine Intellectual Property Company, LLC, Lisle, IL (US)

(21) Appl. No.: 14/374,637

(22) PCT Filed: Feb. 6, 2012
(86) PCT No.: PCT/US2012/023945

§ 371 Date: Jul. 25, 2014

(51) Int. Cl. F02M 55/00; F02M 63/00

(52) U.S. Cl. CPC F02M 55/008; F02M 63/0033
USPC 239/5; 239/584

(57) ABSTRACT

A control valve of a fuel injector includes a generally cylindrical control valve housing having an axis, and a control valve body disposed within the control valve housing. An inlet throttle passage is in fluid communication with the control valve housing and is oriented to be generally tangential to the control valve housing.

### BACKGROUND

Embodiments described herein relate generally to a control valve, and more particularly, to a control valve of a fuel injector for controlling the flow of inlet fuel in an engine.

There are many types of fuel injectors designed to inject fuel into a combustion chamber of an engine. For example, fuel injectors may be mechanically, electrically or hydraulically controlled to inject fuel into the combustion chamber of the engine. A control valve of the fuel injector allows fluid communication of inlet fuel, such as diesel fuel, between an inlet throttle passage and an outlet throttle passage.

The control valve is located in a body plate and a throttle plate of the engine. The body plate and the throttle plate define a generally cylindrical control valve housing. Fuel is introduced into the control valve housing from an inlet throttle passage, through an inlet orifice, and into the control valve housing. In known designs, the inlet throttle passage is oriented generally radially to the generally cylindrical control valve housing.

A control valve body is located within the control valve housing. A driver delivers a current or voltage to an open solenoid, generating a magnetic force to displace the control valve body between an open position permitting the inlet fuel to flow from the control valve housing through an outlet port to the outlet throttle passage, and a closed position not permitting the flow of inlet fuel from the control valve housing to the outlet throttle passage.

In control valves having a generally radial inlet throttle passage, the flow of inlet fuel at the inlet orifice is directed radially to the axis of the control valve housing, creating a large flow force on the control valve body adjacent to the inlet orifice. A large radial flow force on the control valve body may create a stagnant flow condition within the control valve housing such that the inlet fuel may not efficiently flow through the control valve housing from the inlet orifice to the outlet port.

### SUMMARY

In one embodiment, a control valve of a fuel injector includes a control valve housing having an axis, and a control valve body that is displaceable within the control valve housing along the axis. An inlet throttle passage is in fluid communication with the control valve housing and is oriented such that a line projected from the inlet throttle passage having the same orientation as the inlet throttle passage is non-intersecting with the valve body.

In another embodiment, a control valve of a fuel injector includes a generally cylindrical control valve housing having an axis, and a control valve body disposed within the control valve housing. An inlet throttle passage is in fluid communication with the control valve housing and is oriented to be generally tangential to the control valve housing.

Another embodiment provides a method of fluidly communicating inlet fuel from an inlet throttle passage to a valve housing of a fuel injector that includes the steps of introducing the inlet fuel into the inlet throttle passage, orienting the inlet throttle passage to be generally tangential to the valve housing, and fluidly communicating the inlet fuel from the inlet throttle passage through an inlet orifice to the valve housing.

### BRIEF DESCRIPTION OF THE DRAWINGS

FIG. 1 is a side view of a known control valve of a fuel injector for controlling inlet fuel in an engine.

FIG. 2 is an axial top view of the known control valve of a fuel injector for controlling the flow of inlet fuel in an engine.

FIG. 3 is a side view of a control valve of a fuel injector for controlling the flow of inlet fuel in an engine.

FIG. 4 is an axial top view of the control valve of a fuel injector for controlling the flow of inlet fuel in an engine.

FIG. 5 is a cross-section view of the control valve of a fuel injector for controlling the flow of inlet fuel in an engine.

### DETAILED DESCRIPTION

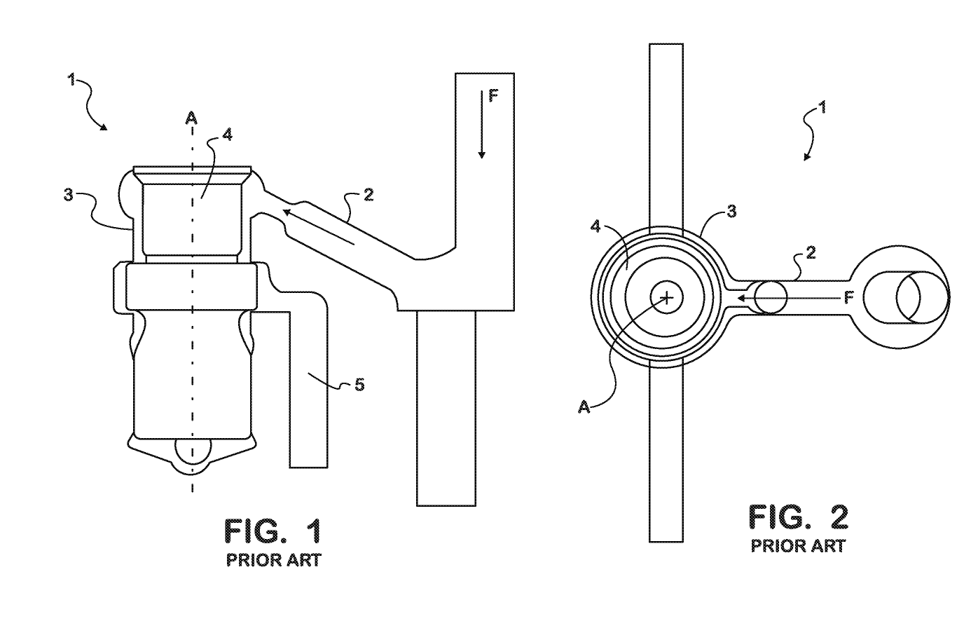

Referring to FIGS. 1 and 2, a known control valve is indicated generally at 1 and includes an inlet throttle passage 2 that is oriented generally radially to an axis A of a control valve housing 3. A control valve body 4 is disposed within the control valve housing 3 and is generally coaxial to the axis A. When inlet fuel F enters the control valve housing 3 in the direction indicated by the arrow, the inlet fuel is directed radially to the axis A of the control valve housing 3 and impinges on the control valve body 4. The flow of inlet fuel F may create a large flow force on the control valve body 4, which may create a stagnant flow condition within the control valve housing 3 such that the inlet fuel F may not efficiently flow through the control valve housing to an outlet throttle passage 5.

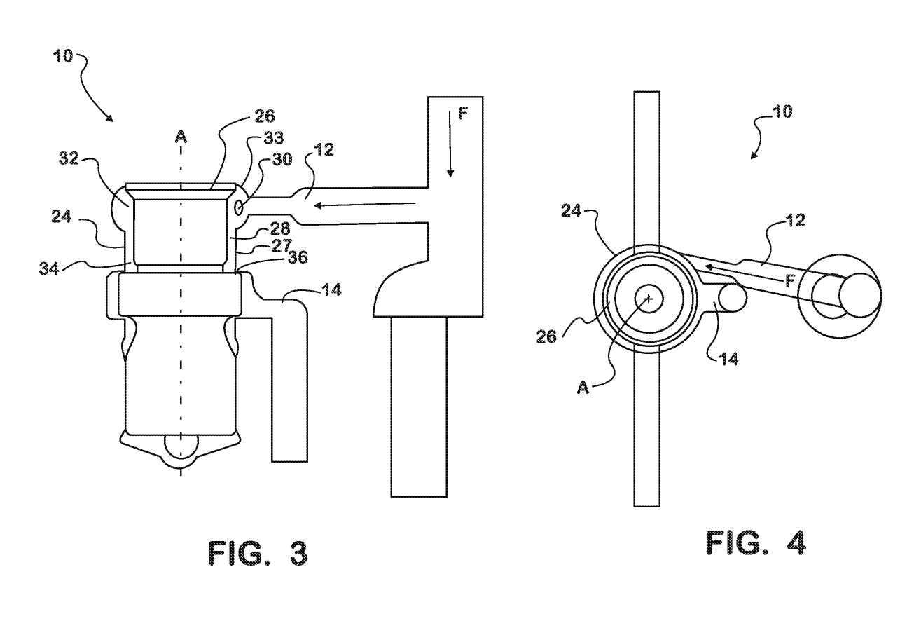

Referring now to FIGS. 3-5, a control valve is indicated generally at 10 and is configured for the selective fluid communication of inlet fuel F between an inlet throttle passage 12 and an outlet throttle passage 14 in a fuel injector 16 of an engine 18. The fuel injector 16 may be mechanically, electrically or hydraulically controlled to inject fuel F into a combustion chamber of the engine 18.

The control valve 10 is located in a body plate 20 and a throttle plate 22 of the engine 18. A generally cylindrical control valve housing 24 is defined by the body plate 20 and the throttle plate 22, and is generally coaxial with an axis A that generally corresponds with the length dimension of the control valve 10. The control valve housing 24 may be generally cylindrical, however other shapes are contemplated. A control valve body 26 is disposed in the control valve housing 24, and is also generally coaxial with the axis A. The control valve body 26 may be generally cylindrical, or have any other shape. Disposed radially between the control valve body 26 and an outer surface 27 of the control valve housing 24 is a control valve passageway 28. The control valve passageway 28 may be generally concentric and coaxial with the axis A, generally concentric and coaxial with the control valve body 26, and may have a variable diameter along the axis A.

The inlet throttle passage 12 may be defined by the body plate 20 and fluidly communicates the inlet fuel F into the control valve housing 24 through an inlet orifice 30. The inlet orifice 30 may be located at a receiving portion 32 of the control valve passageway 28. From the receiving portion 32, the inlet fuel F is communicated to an intermediate portion 34 of the control valve passageway 28. The receiving portion 32 may have a larger diameter than the intermediate portion 34, and may have a variable diameter such that an outer surface 33 is generally curved.

As viewed from the top view of FIG. 4, the inlet throttle passage 12 is oriented to be generally tangential to the control valve housing 24, and generally radially spaced from the axis A. The inlet throttle passage 12 is oriented such that a line projected from the throttle passage at the inlet orifice 30, having the same orientation as the inlet throttle passage, is generally non-intersecting with the valve body 26. It is possible that the inlet throttle passage 12 may be oriented to be generally 45 to 90-degrees from a line extending between the axis A and the inlet orifice 30. It is also possible that the inlet throttle passage 12 may be oriented to be generally 65 to 90-degrees from a line extending between the axis A and the inlet orifice 30. With a non-cylindrical but curved control valve housing 24, the inlet throttle passage 12 may be oriented to be generally tangential to the control valve housing. With a non-curved control valve housing 24, the inlet throttle passage 12 may be oriented such that a line projected from the inlet throttle passage is non-intersecting with the axis A.

The inlet fuel F is introduced into the inlet throttle passage 12, and from the inlet throttle passage 12 the inlet fuel F is introduced into the control valve housing 24 at the inlet orifice 30. Depending on the geometry of the inlet throttle passage 12 and the control valve housing 24 at their junction, the inlet orifice 30 may be generally circular, oval, or have any other geometry. Upon entering the receiving portion 32, the flow of inlet fuel F is directed generally rotationally about the control valve body 26. From the receiving portion 32, the inlet fuel F can flow to the intermediate portion 34 of the control valve passageway 28.

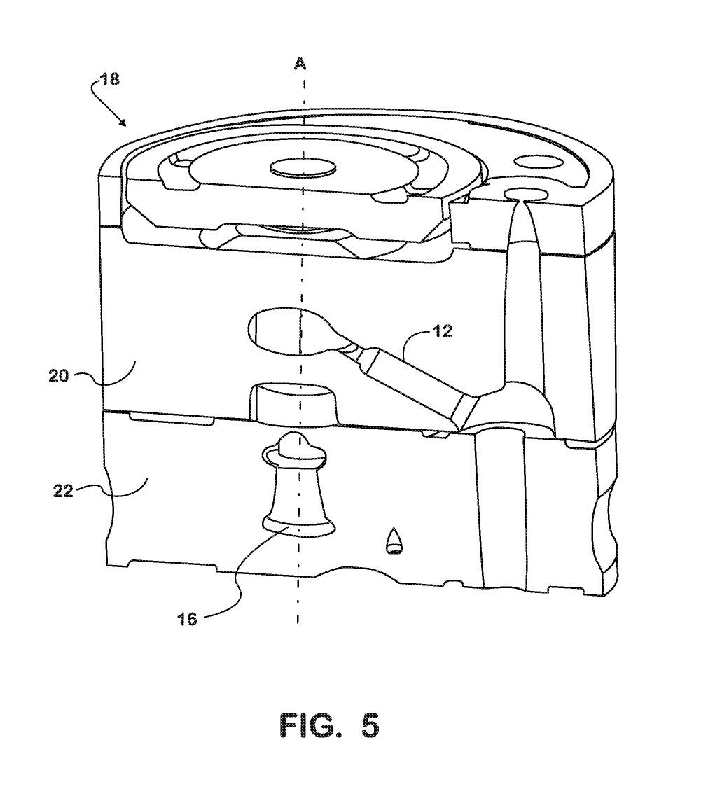

As viewed in the side view of FIG. 3, the inlet throttle passage 12 can be oriented to be generally perpendicular to the axis A, and can also be oriented to be non-perpendicular to axis A, such as seen in FIG. 5. The orientation of the inlet throttle passage 12 as viewed in FIG. 3 and FIG. 5 may be dictated by the constraints of the engine packaging.

A force, such as a magnetic force applied by a solenoid (not shown), displaces the control valve body 26 along axis A between an open position permitting the inlet fuel F to flow from the intermediate portion 32 of the control valve passageway 32 through an outlet port 36 to the outlet throttle passage 14, and a closed position (see FIG. 3) not permitting the flow of inlet fuel F from the control valve passageway to the outlet throttle passage.

With the control valve 10 having a generally tangential inlet throttle passage, the inlet fuel F may apply less force on the control valve body 26, and the fuel injector 16 may operate at higher fuel injection pressure with less external driving force. Instead of a stagnant fluid flow that may be the result of a radially oriented inlet throttle passage, the control valve 10 having a generally tangential inlet throttle passage 12 may allow the inlet fuel F to convert its kinetic energy into rotational flow around the control valve body 26. Further, the flow of inlet fuel F may be more efficiently directed from the inlet orifice 30, through the control valve passageway 28, to the outlet port 36.

What is claimed is:

1. A control valve of a fuel injector comprising:
a control valve housing having an axis;
a control valve body displaceable within the control valve housing along the axis; and
an inlet throttle passage in fluid communication with the control valve housing and oriented such that a line projected from the inlet throttle passage having the same orientation as the inlet throttle passage is non-intersecting with the valve body.

2. The control valve of claim 1 wherein the inlet throttle passage is generally tangential to the control valve housing.

3. The control valve of claim 1 wherein the inlet throttle passage is oriented to be generally 45 to 90-degrees from a line extending between the axis and the inlet orifice.

4. The control valve of claim 1 wherein the inlet throttle passage is oriented to be generally 65 to 90-degrees from a line extending between the axis and the inlet orifice.

5. The control valve of claim 1 wherein the inlet throttle passage is oriented to be generally perpendicular to the axis.

6. The control valve of claim 1 wherein the inlet throttle passage is oriented to be generally non-perpendicular to the axis.

7. The control valve of claim 1 wherein the wherein the control valve housing is generally cylindrical.

8. A control valve of a fuel injector comprising:
a generally cylindrical control valve housing having an axis;
a control valve body disposed within the control valve housing; and
an inlet throttle passage in fluid communication with the control valve housing and oriented to be generally tangential to the control valve housing.

9. The control valve of claim 8 wherein the inlet throttle passage is oriented to be generally perpendicular to the axis.

10. The control valve of claim 8 wherein the inlet throttle passage is oriented to be generally non-perpendicular to the axis

11. The control valve of claim 8 further comprising a control valve passageway disposed radially between the control valve body and an outer surface of the control valve housing.

12. The control valve of claim 11 wherein the control valve passageway is generally concentric and coaxial with the axis, and has a variable diameter along the axis.

13. The control valve of claim 11 wherein the control valve passageway further comprises a receiving portion having a variable diameter.

14. The control valve of claim 8 further comprising an inlet orifice providing fluid communication between the inlet throttle passage and the control valve housing.

15. A method of fluidly communicating inlet fuel from an inlet throttle passage to a valve housing of a fuel injector, the method comprising the steps of:
introducing the inlet fuel into the inlet throttle passage;
orienting the inlet throttle passage to be generally tangential to the valve housing;
fluidly communicating the inlet fuel from the inlet throttle passage through an inlet orifice to the valve housing.
